(19) United States
(12) Patent Application Publication
(10) Pub. No.: US 2019/0266527 A1
(43) Pub. Date: Aug. 29, 2019

(54) EMPLOYEE ENGAGEMENT SERVICE

(71) Applicant: Workforce Accountability Solutions LLC, Cumming, GA (US)

(72) Inventor: Stephen V. Shepherd, Cumming, GA (US)

(21) Appl. No.: 16/176,035

(22) Filed: Oct. 31, 2018

Related U.S. Application Data
(60) Provisional application No. 62/636,357, filed on Feb. 28, 2018.

(51) Int. Cl. G06Q 10/06

(52) U.S. Cl. CPC G06Q 10/0635; G06Q 10/0639

(57) ABSTRACT

Disclosed are various embodiments for systems that gameify employment in order to reduce workforce turnover. An upload of a media item may be received from a client device, the media item and the client device being associated with a user account. A series of requests to view the media item from a set of additional client devices may be tracked. An incentive award can be adjusted based at least in part on the series of requests to view the media item. The incentive award can then be disbursed to the user account at a predefined point in time.

### CROSS-REFERENCE TO RELATED APPLICATIONS

This application claims priority to, and the benefit of, U.S. Provisional Patent Application No. 62/636,357, filed on Feb. 28, 2018 and entitled “Online Audio and Video Employee Training Program,” which is incorporated by reference as if set forth herein in its entirety.

### BACKGROUND

Employee turnover is costly to businesses. When an employee leaves, a new employee must be hired. Training the new employee for his or her job and integrating the new employee into the company can be a costly and time consuming process. A new employee is also often less efficient than the employee that he or she is replacing as the new employee gains experience.

In low wage industries, employee turnover can be quite high. For example, in the restaurant industry, it is not uncommon for employees to change employers every few months. Accordingly, a restaurant that can reduce employee turnover can substantially reduce its costs and increase its productivity due to the retention of experience employees and the reduction in costs associated with training new hires. However, many employers are unable to reduce turnover through traditional approaches, such as increasing pay or providing additional employee benefits, because the employers cannot afford to do so.

Employee engagement, or lack thereof, can also have a significant impact on the operating costs of an enterprise. Operations research has regularly shown that employees that feel vested in their job are more productive and tend to provide more valuable or meaningful contributions. The larger the number of employees who are vested, the more return on investment an enterprise receives on its payroll costs.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a pictorial diagram of an example user interface rendered by a client in the networked environment of FIG. 1 according to various embodiments of the present disclosure.

FIG. 3 is a pictorial diagram of an example user interface rendered by a client in the networked environment of FIG. 1 according to various embodiments of the present disclosure.

FIGS. 4-6 are flowcharts illustrating examples of functionality implemented as portions of applications executed in a computing environment in the networked environment of FIG. 1 according to various embodiments of the present disclosure.

FIG. 7 is a schematic block diagram that provides one example illustration of a computing environment employed in the networked environment of FIG. 1 according to various embodiments of the present disclosure.

### DETAILED DESCRIPTION

Disclosed are various approaches for improving engagement and retention of employees through various gamification techniques. Employees are able to create an account, which is associated with their respective employers. Several scores can be calculated for each employee. A first score may be calculated to represent an employee's work performance (e.g., punctuality/absenteeism, number of write-ups in his or her personnel file, etc.), while a second score may be calculated to represent other intangible measurements of an employee (e.g., ambition, self-improvement, work ethic, etc.). Employees may choose to have these scores shared with other employees in order to participate in a competition to get the highest score. Although the employee with the highest score(s) may win, an employer also benefits because every employee participating in the competition improves their performance as an employee in order to increase his or her score. Employees may also be able to upload content for other users to view or consume, and may be rewarded based on the type of content uploaded and the number of views of the uploaded content. In the following discussion, a general description of the system and its components is provided, followed by a discussion of the operation of the same.

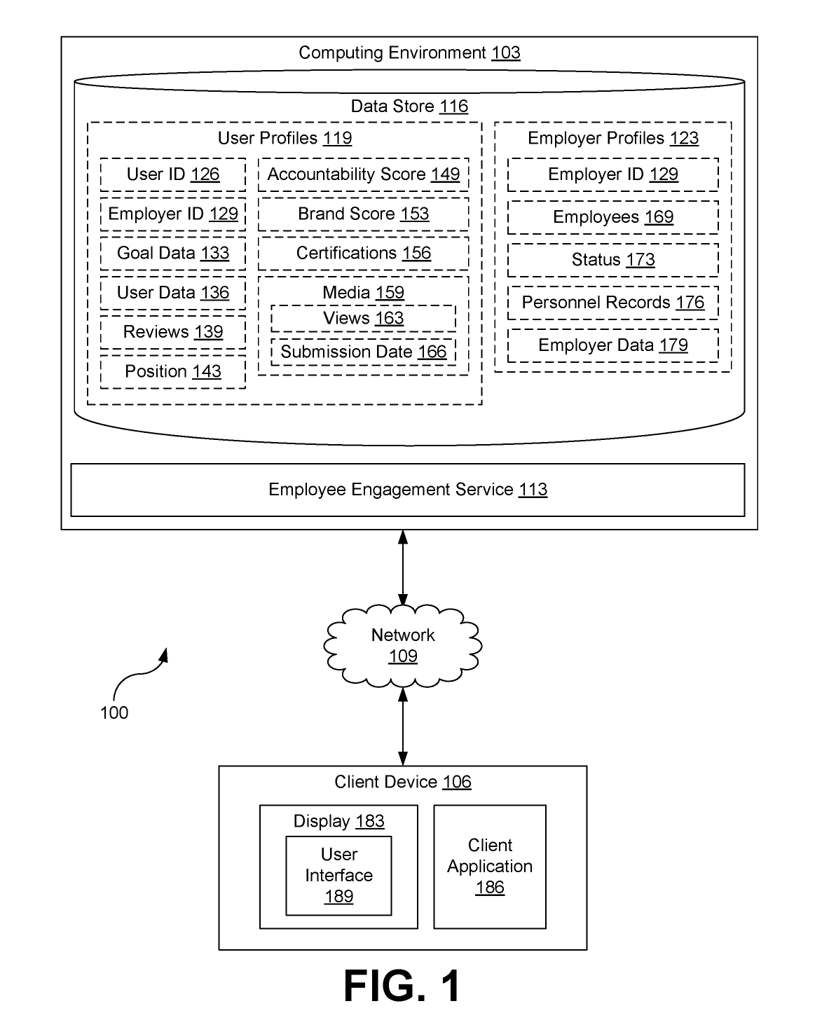

With reference to FIG. 1, shown is a networked environment 100 according to various embodiments. The networked environment 100 includes a computing environment 103, and a client device 106, which are in data communication with each other via a network 109. The network 109 includes wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 may include, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may include a hosted computing resource, a grid computing resource or any other distributed computing arrangement. In some cases, the computing environment 103 may correspond to an elastic computing resource where the allotted capacity of processing, network, storage, or other computing-related resources may vary over time.

Various applications or other functionality may be executed in the computing environment 103 according to various embodiments. The components executed on the computing environment 103, for example, include an employee engagement service 113, and other applications, services, processes, systems, engines, or functionality not discussed in detail herein.

The employee engagement service 113 is executed to provide a social media and sharing platform to incentivize users or employees to stay with an organization or employer for an extended period of time. To accomplish this purpose, the employee engagement service 113 may calculate scores that represent a user and allow those scores to be shared with other users or employees of an organization or company. Moreover, some features of the employee engagement service 113 platform may not be made available to users until they have been members or users of the employee engagement service 113 for a predefined period of time or have maintained continuous membership or employment with the employee engagement service 113 for a predefined period of time. Such features could include the ability to post or upload content and share that content for consumption with other users. To encourage users to post relevant content for other users to consume, the employee engagement service 113 may calculate the amount or value of incentive awards earned through the use of these features and make any earned incentive awards available to the users.

Also, various data is stored in a data store 116 that is accessible to the computing environment 103. The data store 116 may be representative of a plurality of data stores 116, which can include relational databases, object-oriented databases, hierarchical databases, hash tables or similar key-value data stores, as well as other data storage applications or data structures. The data stored in the data store 116 is associated with the operation of the various applications or functional entities described below. This data can include user profiles 119, employer profiles 123, and potentially other data.

The user profiles 119 represent individual persons who are users of the employee engagement service 113. These individual users could include employees of various companies, volunteers of non-profit organizations, or other types of users. Each user profile 119 can include a number of data fields or various kinds of data stored in association with a user profile 119. This data can include a user identifier 126, an employer identifier 129, goal data 133, user data 136, reviews 139, a user's position 143, an accountability score 149, a brand score 153, one or more certifications 156, media 159, and potentially other data.

The user identifier 126 can represent an identifier that uniquely identifies a user profile 119 with respect to another user profile 119. Examples of user identifiers 126 can include character or text strings (e.g., user names), globally unique identifiers (GUIDs), universally unique identifiers (UUIDS), incrementally assigned integers, or other types of unique identifiers. In some instances, a user profile 119 may have multiple user identifiers 126 (e.g., a user name for convenience and a GUID or UUID as well).

The employer identifier 129 can represent an identifier that uniquely identifies an employer profile 123 with respect to another employer profile 123. For the user profile 119, the employer identifier 129 of a user's current employer may be stored. However, the employer identifier 129 for previous employers may also be stored in association with the user profile 119 in some implementations. Examples of employer identifiers 129 can include character or text strings (e.g., company names), globally unique identifiers (GUIDs), universally unique identifiers (UUIDS), incrementally assigned integers, or other types of unique identifiers. In some instances, an employer profile 123 may have multiple employer identifiers 129 (e.g., a company name for convenience and a GUID or UUID as well).

Goal data 133 represents data related to one or more goals that a user may have. The goal data 133 can include the goal set by a user (e.g., to obtain a promotion, to complete a certification, to obtain a raise, etc.) and when the user intends to achieve the goal (e.g., within the next week, month, three months, or other specified time period). The goal data 133 can also reflect whether a user achieved his or her goal and when the user achieved his or her goal (including whether the goal was achieved within the specified time period).

User data 136 reflects information about the user. User data 136 can include the user's name, age or date of birth, location (e.g., home address, city, state, etc.), education level, sex or gender, ethnicity, and potentially other information. User data 136 may be supplied by the user himself or herself, or the user data 136 may be provided by an employer identified by the employer identifier 129 stored in association with the user profile 119. User data 136 can also include information related to when a user profile 119 was created, how long a user has been employed by a current employer identified by the employer identifier 129, and related information. In some instances, user data 136 can also include identifiers of social media accounts of an individual user that the user has provided or contact information for the user provided by the user.

Reviews 139 represent reviews of an employer represented by an employer identifier 129 associated with the user profile 119 or an employee represented by the user profile 119. For example, a review 139 could represent a customer review of an establishment where an employee with a respective user profile 119 works. As another example, a review 139 could represent a customer review of the employee himself or herself. Reviews 139 may be obtained from a number of sources. For example, a review 139 may be retrieved from a third-party review service or site (e.g., YELP®, GOOGLE® Reviews, ANGIE'S LIST®, FACEBOOK®, or similar services). In other instances, a review 139 may be directly submitted through the employee engagement service 113.

A position 143 can reflect the current job title or job position of a user. Examples of positions 143 can include “manager,” “assistant manager,” “shift manager,” “shift supervisor,” “cashier,” “chef,” “waiter/waitress,” “host/hostess,” “maitre D,” “clerk,” “salesperson,” or various other positions. In some instances, the position 143 may be defined by an employer of the user, while in other instances, the position 143 may reflect a user submitted or user selected option.

The accountability score 149 is a score calculated to reflect the reliability or effectiveness of an employee. A higher accountability score 149 can reflect an employee that is more reliable, dependable, or effective. The accountability score 149 can be based at least in part on a variety of factors. For example, an employee's time records might be used to calculate the accountability score 149. The fewer times an employee clocks in late or has an unexcused absence from his or shift, the higher the resulting accountability score 149. Likewise, the more often an employee agrees to cover another employee's shift (e.g., if the employee agrees to cover for the shift of a coworker who called in sick), the higher the resulting accountability score 149. Other factors may also be used to calculate the accountability score 149 for an employee. In some instances, the data used to calculate the accountability score 149 (e.g., time records) may be provided or made accessible by a user's employer.

The brand score 153 is a score calculated to reflect intangible aspects of an employee's contribution or reputation. The higher the brand score 153 for an employee, the more reputable or valuable the employee may be considered. The brand score 153 may be based at least in part on a variety of factors. For example, positive reviews 139 that explicitly mention an employee by name may raise an employee's brand score 153. Likewise, negative reviews 139 that explicitly mention an employee by name may decrease an employee's brand score 153. Positive or negative reviews of the employer that fail to mention the employee may also impact the brand score 153 in similar manners. Goal data 133 may also be used as a factor to determine the brand score 153, with goals that have been achieved within a user's specified timeframe raising the brand score 153 and goals that are achieved outside of the user's specified timeframe raising the brand score 153 to a lesser degree. The number and type of certifications 156 that a user or employee has may also raise or lower a user's brand score 153. Likewise, the number of media 159 items that a user has uploaded may also impact a user's brand score 153, as well as the number of views 163 that each media 159 item has. Other factors may also be used to calculate the brand score 153. Moreover, the impact of some items may decay over time. For instance, older reviews 139 (positive or negative) may have less of an impact on a user's brand score 153 than newer reviews 139.

Certifications 156 represent a confirmation issued by an accredited third-party that a user or employee has a requisite skill. In some instances, a certification 156 could also include a license when the certifying party is a governmental agency. Examples of certifications 156 include internal or company certifications (e.g., a certificate that an employee has completed an internal training course offered by his or her employer), vendor or product certifications (e.g., certifications by a vendor or manufacturer that an individual is qualified to use the vendor's product(s) or has received special training for how to use the products), and professional certifications (e.g., a certification offered by a professional organization or governing professional body in a particular field). A record for a certification 156 may include the type of certification 156 (e.g., company, vendor or product, or professional), the name of the certification 156, the date the certification 156 was obtained, the date the certification 156 expires, and similar information.

Media 159 represents digital content uploaded by a user. Examples of such digital content include videos, audio content (e.g., podcasts, audio interviews, lectures, discussions, etc.), pictures or images (e.g., illustrations, instructional diagrams, motivational images, etc.), and text content (e.g., essays, educational stories or parables, and similar content). As further described herein, users may be invited or permitted to upload media 159 after a user has been employed with the same employer represented by the employer identifier 129 for a predefined length of time. For each item of media 159, the views 163 of the media 159 and the submission date 166 of the media 159 may also be stored in association with the media 159.

The views 163 represent the number of times an item of media 159 has been consumed. Each individual view 163 of an item of media 159 may also include information such as the date that the item of media 159 was consumed and the user identifier 126 of the user who consumed the item of media 159. For example, a view 163 may represent the user identifier 126 of the user who viewed a video and the time that the user viewed video. Similarly, a view 163 may represent the user identifier 126 of the user who listened to or downloaded a podcast episode and the time that the user consumed the podcast.

The submission date 166 represents the date and time that an item of media 159 was uploaded from a client device 106 to the data store 116 by a user. The submission date 166 may be used by the employee engagement service 113 as a basis for updating the brand score 153 of a user profile 119 or as a basis for surfacing media 159 to other users. For example, older media 159 submitted by a user may be less heavily weighted when calculating the brand score 153 than more recently submitted media 159. Likewise, older media 159 may be less likely to be surfaced to other users as it is less likely to be relevant or fresh compared to more recently submitted media 159.

The employer profiles 123 represent employers of employees with user profiles 119 or other organizations with members that have user profiles 119. Each employer profile 123 may be created when an employer registers with the employee engagement service 113. Alternatively, an employer profile 123 may be created automatically by the employee engagement service 113 when a user profile 119 is created that identifies an employer without a preexisting employer profile 123. Such a “shadow” or “placeholder” employer profile 123 may be maintained until it is claimed by the employer at a later time, such as when an employer subsequently registers with the employee engagement service 113.

Each employer profile 123 may include various types of information. Such information can include the employer identifier 129 described above, a list of employees 169, a status 173 of the employer, one or more personnel records 176, and employer data 179. Other information may also be stored in an employer profile 123 as would be appropriate for specific implementations of the present disclosure.

The list of employees 169 represents a list of employees of an employer, or members of an organization, who have registered with the employee engagement service 113. The list of employees can include, for example, the set or list of user identifiers 126 that identify the user profiles 119 of the employees of an employer or members of an organization.

The status 173 represents the registration status of an employer or organization with the employee engagement service 113. The status may indicate that an employer or organization is registered or unregistered. A registered employer or organization is one that has registered itself or is currently registered to use the employee engagement service 113. An unregistered employer or organization is one that has employees or members with user profiles 119, but has not yet registered itself to use or is not currently registered to use the employee engagement service 113.

The personnel records 176 represent employee records or data provided by the employer. Personnel records 176 may be used as a basis for the accountability score 149 of individual employees. Accordingly, personnel records 176 may include information such as employee time or attendance records, employee disciplinary records (e.g., a number of write-ups or disciplinary actions, the type or category of incident leading to the write-up or disciplinary action, and similar data), etc. Other information may also be reflected in personnel records 176 according to various embodiments of the present disclosure, such as the length of employment of the user with the employer.

The employer data 179 represents information about the employer or organization itself. Employer data 179 could include the name of the employer or organization, the location or locations of the employer or organization (e.g., the address or location of each store or restaurant in a chain, each branch office of a company, each manufacturing plant, warehouse, or distribution center of a company, etc.), a list of social media accounts associated with the employer or organization, and potentially other data.

The client device 106 is representative of a plurality of client devices that may be coupled to the network 109. The client device 106 may include, for example, a processor-based system such as a computer system. Such a computer system may be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 may include one or more displays 183, such as liquid crystal displays (LCDs), gas plasma-based flat panel displays, organic light emitting diode (OLED) displays, electrophoretic ink (“E-ink”) displays, projectors, or other types of display devices. In some instances, the display 183 may be a component of the client device 106 or may be connected to the client device 106 through a wired or wireless connection.

The client device 106 may be configured to execute various applications such as a client application 186 or other applications. The client application 186 may be executed in a client device 106, for example, to access network content served up by the computing environment 103 or other servers, thereby rendering a user interface 189 on the display 183. To this end, the client application 186 may include, for example, a browser, a dedicated application, or other executable and the user interface 189 may include a network page, an application screen, or other user mechanism for obtaining user input. The client device 106 may be configured to execute applications beyond the client application 186, such as, for example, email applications, social networking applications, word processors, spreadsheets, or other applications.

Next, a general description of the operation of the various components of the networked environment 100 is provided. The operation of individual components will be described in further detail in the discussion of the subsequent figures.

To begin, a user registers for a user account with the employee engagement service 113. In response, the employee engagement service 113 can create a user profile 119 for the user. The request may be made, for example, through a user interface 189 that provides for registration functionality.

As part of the registration process, the user provides various types of information. This can include user data 136 (e.g., name, age, location, education level, etc.), the user's current employer, the user's current position 143 with the employer, and proof of one or more certifications 156. When identifying the current employer of the user, the employee engagement service 113 may allow the user to select an employer from the employer profiles 123 already created within the system or allow the user to identify a new employer. In response, the employee engagement service 113 can add the user identifier 126 of the newly created user profile 119 to the list of employees 169 of the employer profile 123 of the user's employer. If an employer profile 123 does not currently exist for the user's current employer, the employee engagement service 113 may create an employer profile 123 for the user's employer. In some instances, the employee engagement service 113 may send an automated request (e.g., an email, a text message, etc.) to the employer to invite them to register with the employee engagement service 113 and create an employer profile 123 with the employee engagement service 113.

In some embodiments, the employee engagement service 113 may additionally send a verification request to the employer prior to adding the user profile to the list of employees 169 for the employer profile 123 of the employer. The verification request may include the name and other relevant information of the employee, along with a request that the employer verify that the user associated with the user profile 119 is a current employee of the employer. Once the employer has verified the user is in fact a current employee, the user identifier 126 may then be added to the list of employees 169 in some embodiments of the present disclosure.

Once an employee is registered, the employee engagement service 113 can calculate both an accountability score 149 for the employee and a brand score 153 for the employee. The accountability score 149 and the brand score 153 may then be updated on a periodic basis.

The accountability score 149 may be calculated using various factors. For example, the accountability score 149 may be based at least in part on respective personnel records 176 related to employee, such as time or attendance records, and other factors. In those instances where no personnel records 176 from an employer are available (e.g., the employer has not registered with the employee engagement service 113 or provided the respective personnel records 176), the employee engagement service 113 may defer calculating an accountability score 149 until such data is available. In some instances, the accountability score 149 may be weighted, with more recent performance metrics (e.g., more recent time records in an employee's respective personnel records 176 provided by an employer) having a greater impact on the resulting accountability score 149 than earlier performance metrics. In some instances, the accountability score 149 may be normalized so that the accountability score 149 can provide an accurate comparison between two users with different sets of personnel records 176 provided by an employer.

The brand score 153 may be calculated using various factors. For example, the number of items of media 159 submitted by a user may be considered, as well as the number of views 163 of each item of media 159. Goal data 133 may also be considered, with the acts of setting and achieving goals increasing the brand score 153 while failure to set goals or failure to achieve goals may decrease the brand score 153. The number and type of certifications 156 that a user has obtained may also be used as a factor in calculating the brand score 153. Likewise, reviews 139 that are associated with a user may influence the brand score 153, with positive reviews 139 increasing the brand score 153, and negative reviews decreasing the brand score 153. In some instances, reviews 139 that specifically identify an employee or user may be given a greater weight than reviews that are merely associated with the employer or the specific location of an employer (e.g., a specific franchise location).

In some instances, the brand score 153 of other employees or users may impact a user's personal brand score 153. For example, a user or employee with a supervisory role may have his or her personal brand score 153 based at least in part on the personal brand scores 153 of his or her direct reports. This may be done to take into account the ability of a supervisor to motivate or engage his or her direct reports.

The employer and/or the employee may choose to share the accountability scores 149 or the brand scores 153 of individual users with selected other users. For example, an employer may select to share the accountability score 149 or the brand score 153 of individual employees with other employees. This could be done in a tabulated, ranked, or “leaderboard” format showing the individuals employees ranked by accountability score 149 and/or brand score 153. This could be done as part of a contest, for example, to see which employee could have the highest accountability score 149 or brand score 153 at the end of a predefined period of time (e.g., end of a week, end of a month, end of a quarter, end of a year, etc.) or the largest improvement to an accountability score 149 or brand score 153 at the end of the predefined period of time. As another example, an employee could choose to have a web page representing the user profile 119 of individual users made publicly available to other users in order to advertise, brag, or otherwise display their accountability score 149 or brand score 153.

Once a user has registered with the employee engagement service 113, the employee engagement service 113 may determine whether or not a user is qualified or permitted to upload items of media 159. For example, users may be invited to begin uploading items of media 159 after they have been employed with their current employer for a predefined period of time (e.g., six months, nine months, a year, etc.). Similarly, users may be invited to begin uploading items of media 159 after they have been registered with the employee engagement service 113 for a predefined period of time (e.g., six months, nine months, a year, etc.).

As later described herein, the items of media 159 that a user uploads can be the basis for incentive rewards provided to a user. To incentivize employees to stay with their current employer for a minimum period of time, employees are not provided with immediate access to the portions of the employee engagement service 113 until after a predefined period of time has passed. This can help employers reduce turnover of employees, thereby boosting productivity.

For example, at periodic intervals, the employee engagement service 113 may evaluate a user profile 119 to determine whether or not an employee is qualified for an incentive award. Whether or not the user qualifies to receive an incentive award can be based on one or more factors. For instance, users may receive incentive awards for uploading items of media 159. The employee engagement service 113 may also evaluate the user profile 119 to determine whether the user qualifies for additional or larger incentive awards. For instance, the number of views 163 may be used as a basis to increase the incentive award, with each view 163 or each view within a predefined preceding period of time acting as a basis for an increase in the incentive award.

Incentive awards may take a variety of forms. For example, incentive awards could include cash or cash equivalents (e.g., store credits, gift cards, etc.) as well as non-monetary compensation (e.g., paid time off). To use the example of an incentive award that includes a cash or cash equivalent, a user could qualify for an initial base award (e.g., $0.25) for each item of media 159 that the user uploads. Each new view 163 of the item of media 159 could then qualify the user for an additional incentive (e.g., $0.01 per view 163). However, other amounts may be used in various embodiments.

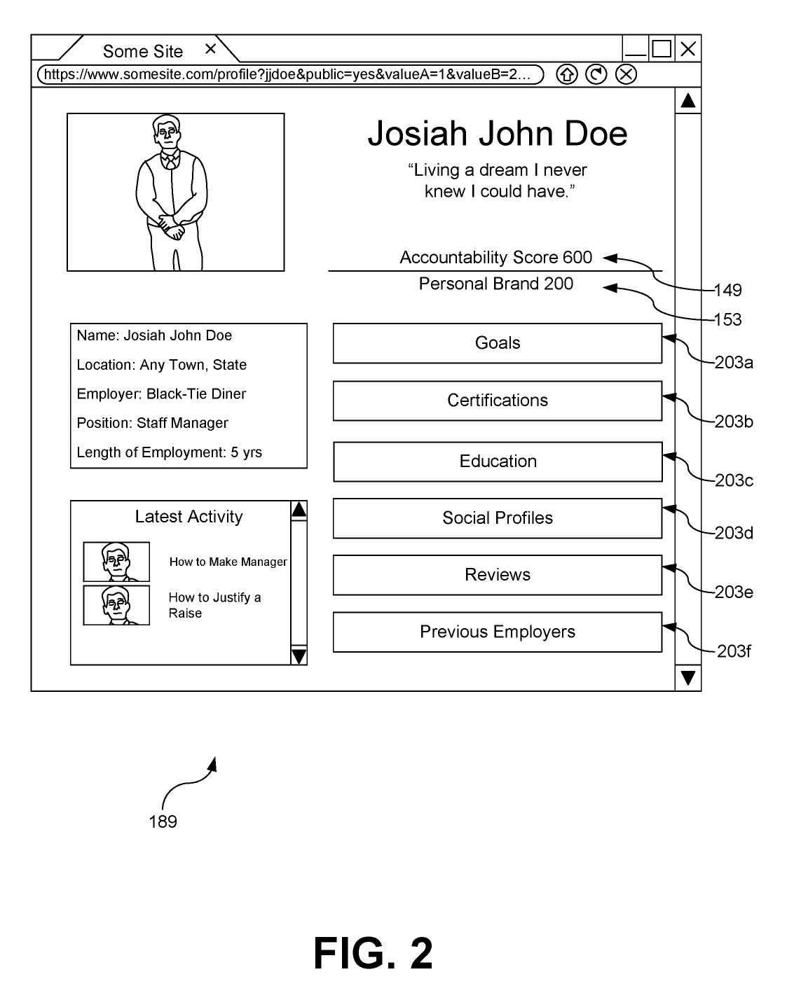

Referring next to FIG. 2, shown is a depiction of a sample user interface 189 rendered on the display 183 (FIG. 1) of the client device 106 (FIG. 1). Other user interfaces 189 may be implemented in various embodiments of the present disclosure to achieve the same or similar functionality. For example, some user interfaces 189 may be rendered as web pages displayed by a browser while other user interfaces 189 may be rendered as application interfaces for dedicated applications executing on a client devices 106 (e.g., a mobile application executed by a mobile device).

The user interface 189 depicted in FIG. 2 may allow an individual to view a user profile 119 (FIG. 1) of a user of the employee engagement service 113. For example, the accountability score 149 and the brand score 153 of the user may be depicted within the user interface 189. Likewise, a number of user interface elements 203a, 203b, 203c, 203d, 203e, and 203f may be rendered within the user interface 189. Each user interface element 203 may be manipulable by a user to view the goal data 133 (FIG. 1), certifications 156 (FIG. 1), reviews 139 (FIG. 1), current position 143 (FIG. 1), and user data 136 (FIG. 1) (e.g., linked social media profiles, education, current employer, previous employer, etc.). If the user represented by the user profile 119 represented in the browser, mobile application, or other client application 186 (FIG. 1) rendering the user interface 189 is logged in or otherwise authenticated, then the user may be able to update or edit the displayed information.

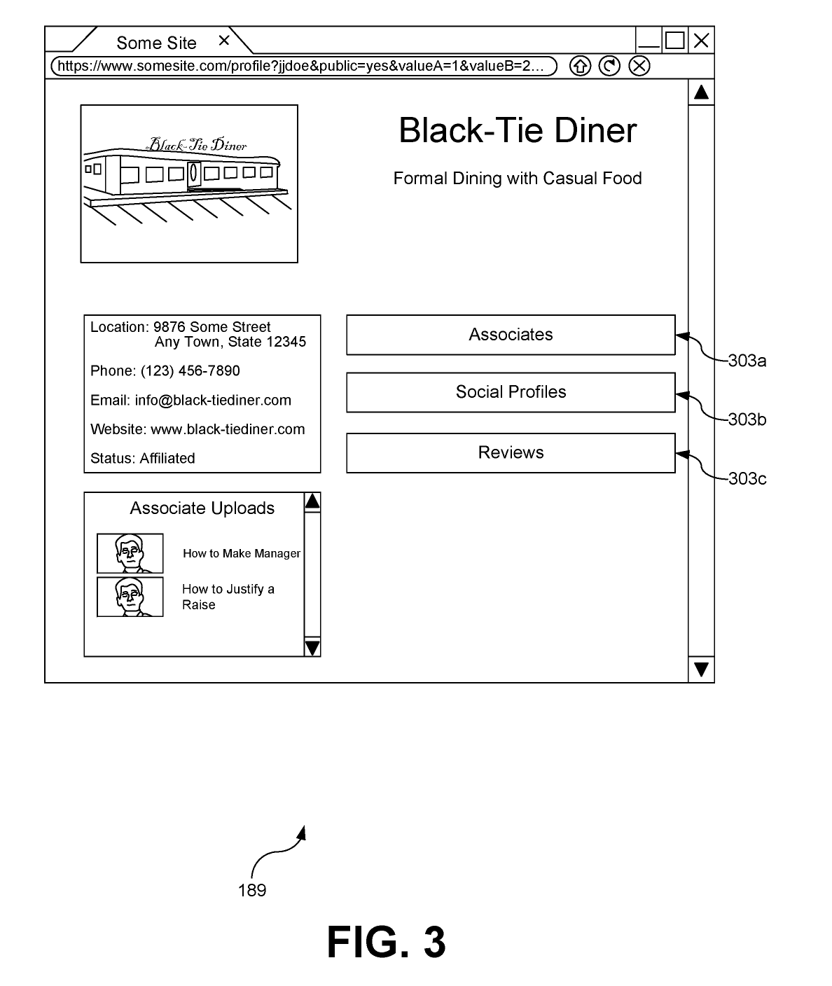

Turning now to FIG. 3, shown is another depiction of a sample user interface 189 rendered on the display 183 (FIG. 1) of the client device 106 (FIG. 1). Other user interfaces 189 may be implemented in various embodiments of the present disclosure to achieve the same or similar functionality. For example, some user interfaces 189 may be rendered as web page displayed by a browser while other user interfaces 189 may be rendered as application interfaces for dedicated applications executing on a client devices 106 (e.g., a mobile application executed by a mobile device).

The user interface 189 depicted in FIG. 3 may allow an individual to view an employer profile 123 (FIG. 1) of an employer. For example, the employer data 179 (FIG. 1) may be displayed (e.g., location, contact information, name, etc.), the status 173 of the employer may be displayed, and a number of user interface elements 303a, 303b, and 303c may also be rendered within the user interface 189. Each user interface element 303 may be manipulable by a user to view the list of employees 169 (FIG. 1) associated with the employer, social media profiles of the employer, and reviews 139 associated with individual employees of the employer. If the employer profile 123 is an affiliated or registered employer, then a representative of the employer may be able to edit or update some of the data. For example, a representative of a registered or affiliated employer could verify the identities of employees, add or remove employees, and perform similar actions.

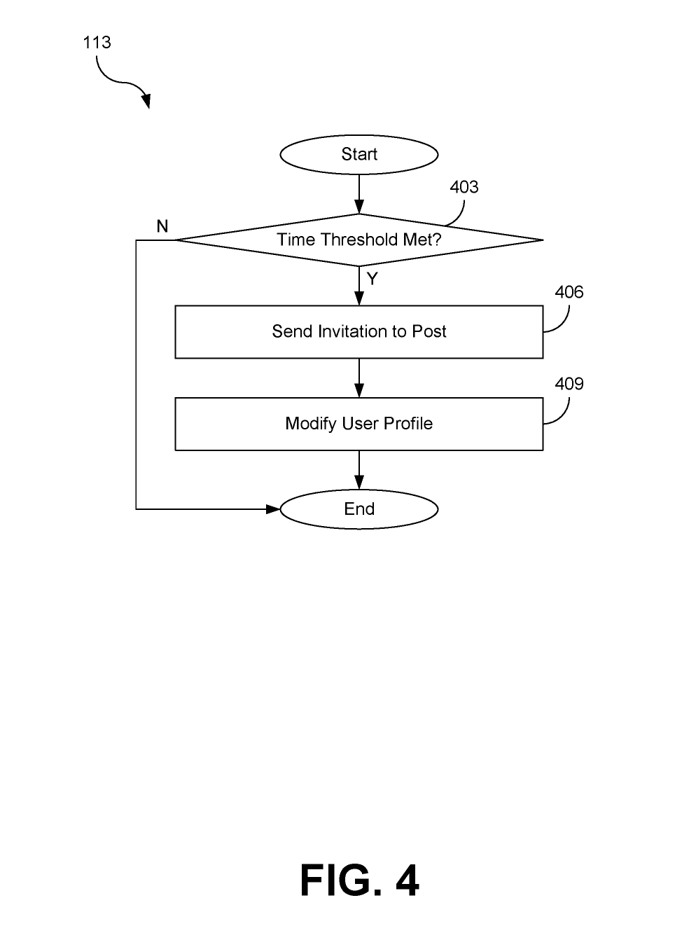

Referring next to FIG. 4, shown is a flowchart that provides one example of the operation of a portion of the employee engagement service 113 according to various embodiments. It is understood that the flowchart of FIG. 4 provides merely an example of the many different types of functional arrangements that may be employed to implement the operation of the portion of the employee engagement service 113 as described herein. As an alternative, the flowchart of FIG. 4 may be viewed as depicting an example of elements of a method implemented in the computing environment 103 (FIG. 1) according to one or more embodiments.

Beginning with box 403, the employee engagement service 113 periodically evaluates each user profile 119 (FIG. 1) to determine whether or not the user associated with the user profile 119 has been employed with his or her current employer for a predefined period of time or whether the user associated with the user profile 119 has been registered with the employee engagement service 113 for a predefined period of time. For example, the employee engagement service 113 may reference the employer profile 123 linked to the user profile 119 by the employer identifier 129 and query one or more personnel records 176 to determine the length of a user's current employment. As another example, the employee engagement service 113 may query the user data 136 of the user profile 119 to determine when the user first registered with the employee engagement service 113 or the length of an employee's service. If the user's length of employment with the employer meets or exceeds the predefined threshold period of time, or if the user's registration date is prior to the predefined period of time, then the employee engagement service 113 proceeds to box 406. Otherwise, the operation of this portion of the employee engagement service 113 ends.

Next at box 406, the employee engagement service 113 can send an invitation to the user to begin posting or otherwise uploading items of media 159 (FIG. 1). For example, the employee engagement service 113 may reference a user's cell phone or email address listed in the user data 136 of his or her user profile 119. The employee engagement service 113 can then send a short message service (SMS) message or electronic mail (E-Mail) to the user notifying the user that he or she now has permission to upload items of media 159 to the employee engagement service 113.

Then at box 409, the employee engagement service 113 may also modify the user profile 119 for the user to indicate that the user is allowed to upload or share items of media 159. For example, the employee engagement service 113 may alter a permission associated with the user profile 119 controls whether or not the user is able to upload items of media 159. Once the permission is altered, the user is able to upload items of media 159 to his or her user profile 119, which can then be shared with and viewed by other users.

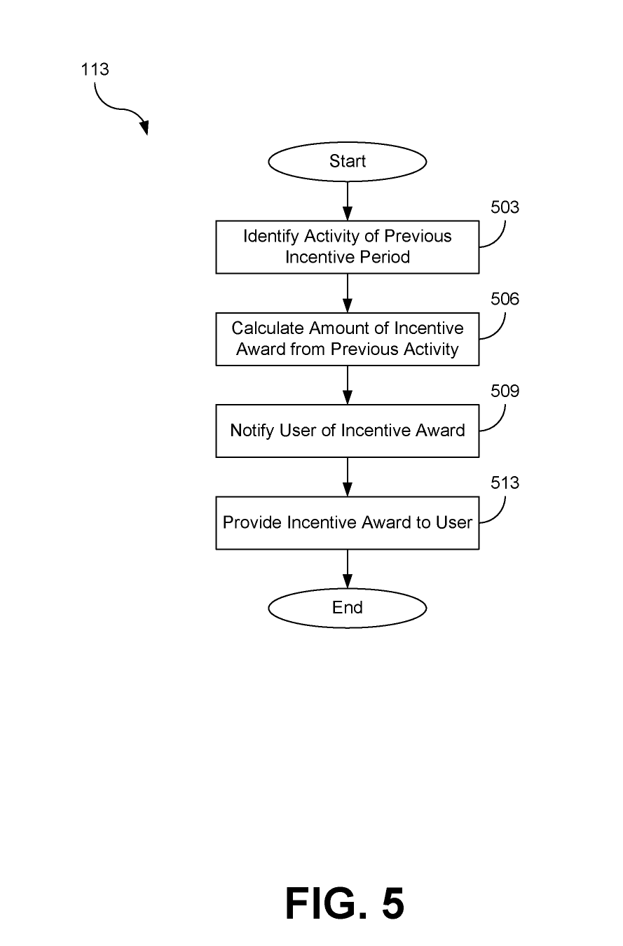

Referring next to FIG. 5, shown is a flowchart that provides one example of the operation of a portion of the employee engagement service 113 according to various embodiments. It is understood that the flowchart of FIG. 5 provides merely an example of the many different types of functional arrangements that may be employed to implement the operation of the portion of the employee engagement service 113 as described herein. As an alternative, the flowchart of FIG. 5 may be viewed as depicting an example of elements of a method implemented in the computing environment 103 (FIG. 1) according to one or more embodiments.

Beginning with box 503, the employee engagement service 113 identifies incentive eligible activity related to a user profile 119 (FIG. 1) that has occurred during a previous incentive period. An incentive period is a predefined period of time in which activity that is rewarded with incentive awards may qualify as the basis for an incentive award. For example, incentive awards may be awarded to users or employees every week, every month, every quarter, or at other periods of time.

Eligible activity can include any type of user activity previously approved as a basis for an incentive award. For example, the employee engagement service 113 might identify the number of items of media 159 (FIG. 1) that a user uploaded within the previous incentive period. As another example, the employee engagement service 113 may identify the number of views 163 (FIG. 1) of the item of media 159 that occurred during the previous incentive period or the number of instances in which another user shared an uploaded item of media 159.

Next at box 506, the employee engagement service 113 can calculate the amount of the incentive award owed to the user based at least in part on the identified eligible activity. For example, the amount of the incentive award may be calculated according to a preset schedule, with a specific number of “points” or units of currency being awarded for each instance of eligible activity. For example, a first amount of points or amount of currency may be awarded to a user based on each instance of a new item of media 159 the user creates and/or uploads to the employee engagement service 113. As another example, a second amount of points or currency may be awarded to the user for each view 163 or share of an item of media 159 previously uploaded or submitted by the user. In those instances where “points” are awarded instead of currency, the points may be redeemable for cash or cash equivalents. For example, points may be redeemed for gift cards from various merchants.

Then at box 509, the employee engagement service 113 sends a notification to the user that he or she has earned an incentive award and the amount of the incentive award earned from the previous incentive period. In some instances, the notification may also include a total amount earned by the user or owed to the user (e.g., unredeemed points, cash, or cash equivalents). Accordingly, the employee engagement service 113 may reference a user's cell phone or email address listed in the user data 136 of his or her user profile 119. The employee engagement service 113 can then send a short message service (SMS) message or electronic mail (E-Mail) to the user notifying them of their current incentive award.

In some instances, the user may be required to redeem his or her incentive award (e.g., by selecting a gift card from a participating merchant and an amount of the gift card). However, in some instances, the employee engagement service 113 may be able to automatically credit the user with his or her incentive award. For example, if the user is due to receive a cash incentive award, then the employee management service 113 may cause an automatic deposit to be made to a user's bank account on file as part of the user data 136 (FIG. 1) of the use profile.

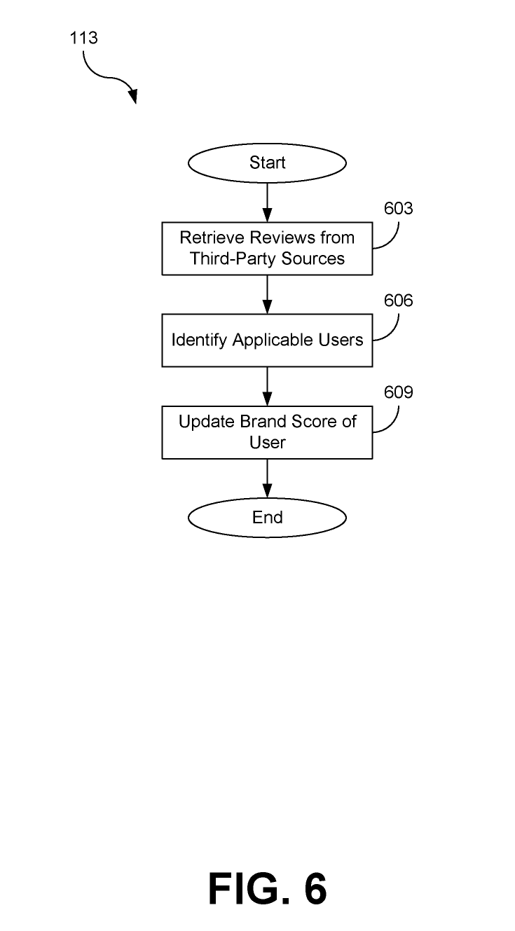

Referring next to FIG. 6, shown is a flowchart that provides one example of the operation of a portion of the employee engagement service 113 according to various embodiments. It is understood that the flowchart of FIG. 6 provides merely an example of the many different types of functional arrangements that may be employed to implement the operation of the portion of the employee engagement service 113 as described herein. As an alternative, the flowchart of FIG. 6 may be viewed as depicting an example of elements of a method implemented in the computing environment 103 (FIG. 1) according to one or more embodiments.

Beginning with box 603, the employee engagement service 113 retrieves reviews 139 (FIG. 1) from third-party review services or sites. For example, the employee engagement service 113 may scrape the third-party review service or site to retrieve individual reviews 139 for a specific company, organization, employer, or specific location of a company or employer when there are multiple locations (e.g., multiple stores, franchise, offices, etc.). Reviews 139 may be retrieved at periodic intervals (e.g., daily, weekly, monthly, etc.).

Then at box 606, the employee engagement service 113 can identify the applicable user profiles 119 (FIG. 1) for a retrieved review 139. For example, if a review 139 is for a specific employer, each user profile 119 in the list of employees 169 for the employer may be linked to the review 139. Likewise, if a review 139 specifies a particular individual(s), then the user file 119 for the individual(s) may be linked to the review 139.

Next at box 609, the employee engagement service 113 updates the brand score 153 (FIG. 1) for a user profile 119. To update the brand score, the employee engagement service 113 may assign a positive or negative numerical value to each review 139. The employee engagement service 113 may also reference the goal data 133 and assign a positive or negative numerical value to each goal that a user has set based on whether or not the goal was achieved. Goals that have been achieved outside of a timeframe specified by the user to achieve the goal may be weighted less than goals that were achieved within the specified time frame set by the user. Numerical values may also be assigned to certifications 156 obtained by a user, with some certifications 156 being weighted more than other types of certifications 156. For example, state or professional licenses may be weighted more heavily than vendor or product specific certifications 156, which may be weighted more heavily than certifications 156 offered internally within a company. Whether or not a user has posted items of media 159 may also be considered, with items of media 159 that have more views 163 being weighted more heavily than items of media 159 with fewer views. Likewise, items of media 159 with a more recent submission date 166 may be weighted more heavily than older items of media 159. Other factors may also be used to calculate a brand score 153 and weighted as desired. Once the new brand score 153 for the user or employee is calculated, it can be stored in the user profile 119 for the user.

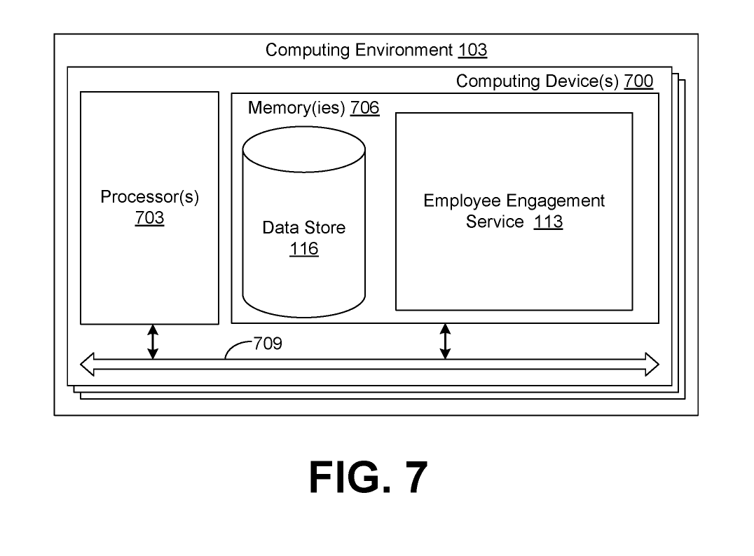

With reference to FIG. 7, shown is a schematic block diagram of the computing environment 103 according to an embodiment of the present disclosure. The computing environment 103 includes one or more computing devices 700. Each computing device 700 includes at least one processor circuit, for example, having a processor 703 and a memory 706, both of which are coupled to a local interface 709. To this end, each computing device 700 may include, for example, at least one server computer or like device. The local interface 709 may include, for example, a data bus with an accompanying address/control bus or other bus structure as can be appreciated.

Stored in the memory 706 are both data and several components that are executable by the processor 703. In particular, stored in the memory 706 and executable by the processor 703 are the employee engagement service 113 and potentially other applications. Also stored in the memory 706 may be a data store 116 and other data. In addition, an operating system may be stored in the memory 706 and executable by the processor 703.

It is understood that there may be other applications that are stored in the memory 706 and are executable by the processor 703 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

Also, the processor 703 may represent multiple processors 703 or multiple processor cores and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706. The local interface 709 may include additional systems designed to coordinate this communication, including, for example, performing load balancing. The processor 703 may be of electrical or of some other available construction.

Although the employee engagement service 113 and other various systems described herein may be embodied in software or code executed by general purpose hardware as discussed above, as an alternative, the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4-6 show the functionality and operation of an implementation of portions of the employee engagement service 113. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor 703 in a computer system or other system. The machine code may be converted from the source code through various processes. For example, the machine code may be generated from the source code with a compiler prior to execution of the corresponding application. As another example, the machine code may be generated from the source code concurrently with execution with an interpreter. Other approaches can also be used. If embodied in hardware, each block may represent a circuit or a number of interconnected circuits to implement the specified logical function or functions.

Although the flowcharts of FIGS. 4-6 show a specific order of execution, it is understood that the order of execution may differ from that which is depicted. For example, the order of execution of two or more blocks may be scrambled relative to the order shown. Also, two or more blocks shown in succession in FIGS. 4-6 may be executed concurrently or with partial concurrence. Further, in some embodiments, one or more of the blocks shown in FIGS. 4-6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the employee engagement service 113, that includes software or code can be embodied in any non-transitory computer-readable medium for use by or in connection with an instruction execution system such as, for example, a processor 703 in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM), including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the employee engagement service 113, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 700, or in multiple computing devices in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine readable instructions stored in the memory that, when executed by the processor, cause the computing device to at least:
receive an upload of a media item from a client device, the media item and the client device being associated with a user account;
track a series of requests to view the media item from a set of additional client devices;
adjust an incentive award based at least in part on the series of requests to view the media item; and
disburse the incentive award to the user account at a predefined point in time.

2. The system of claim 1, wherein the machine readable instructions, when executed by the processor, further cause the computing device to at least:
register the user account in association with an organizational account;
subsequently determine that the user account has been associated with the organizational account for at least a predefined period of time; and
wherein receipt of the upload of the media item is conditioned upon a determination that the user account has been associated with the organizational account for at least the predefined period of time.

3. The system of claim 1, wherein the machine readable instructions that, when executed by the processor, cause the computing device to adjust the incentive award further cause the computing device to at least adjust the incentive award based at least in part on a number of media items uploaded from the user account.

4. The system of claim 1, wherein a score is stored in association with the user account and the machine readable instructions, when executed by the processor, further cause the computing device to at least:
track consumption of media content by the user account; and
adjust the score associated with the user account based at least in part on the consumption of media content.

5. The system of claim 4, wherein the machine readable instructions, when executed by the processor, further cause the computing device to at least adjust the incentive award based at least in part on the score.

6. The system of claim 1, wherein a score is stored in association with the user account, and the machine readable instructions, when executed by the processor, further cause the computing device to at least:
scrape a previously identified web page to identify a review associated with an organizational account associated with the user account;
evaluate the review; and
adjust the score based at least in part on an evaluation of the review.

7. The system of claim 6, wherein the machine readable instructions, when executed by the processor, further cause the computing device to at least adjust the incentive award based at least in part on the score.

8. A method, comprising:
receiving an upload of a media item from a client device, the media item and the client device being associated with a user account;
tracking a series of requests to view the media item from a set of additional client devices;
adjusting an incentive award based at least in part on the series of requests to view the media item; and
disbursing the incentive award to the user account at a predefined point in time.

9. The method of claim 8, further comprising:
registering the user account in association with an organizational account;
subsequently determining that the user account has been associated with the organizational account for at least a predefined period of time; and
wherein receipt of the upload of the media item is conditioned upon a determination that the user account has been associated with the organizational account for at least the predefined period of time.

10. The method of claim 8, wherein adjusting the incentive award further comprises adjusting the incentive award based at least in part on a number of media items uploaded from the user account.

11. The method of claim 8, further comprising:
storing a score in association with the user account;
tracking consumption of media content by the user account; and
adjusting the score associated with the user account based at least in part on the consumption of media content.

12. The method of claim 11, further comprising adjusting the incentive award based at least in part on the score.

13. The method of claim 8, further comprising:
storing a score with the user account;
scraping a previously identified web page to identify a review associated with an organizational account associated with the user account;
evaluating the review; and
adjusting the score based at least in part on an evaluation of the review.

14. The method of claim 13, further comprising adjusting the incentive award based at least in part on the score.

15. A non-transitory computer readable medium comprising machine readable instructions that, when executed by a processor, cause a computing device to at least:
receive an upload of a media item from a client device, the media item and the client device being associated with a user account;
track a series of requests to view the media item from a set of additional client devices;
adjust an incentive award based at least in part on the series of requests to view the media item; and
disburse the incentive award to the user account at a predefined point in time.

16. The non-transitory computer readable medium of claim 15, wherein the machine readable instructions, when executed by the processor, further cause the computing device to at least:
register the user account in association with an organizational account;
subsequently determine that the user account has been associated with the organizational account for at least a predefined period of time; and
wherein receipt of the upload of the media item is conditioned upon a determination that the user account has been associated with the organizational account for at least the predefined period of time.

17. The non-transitory computer readable medium of claim 15, wherein the machine readable instructions that, when executed by the processor, cause the computing device to adjust the incentive award further cause the computing device to at least adjust the incentive award based at least in part on a number of media items uploaded from the user account.

18. The non-transitory computer readable medium of claim 15, wherein a score is stored in association with the user account and the machine readable instructions, when executed by the processor, further cause the computing device to at least:
track consumption of media content by the user account; and
adjust the score associated with the user account based at least in part on the consumption of media content.

19. The non-transitory computer readable medium of claim 15, wherein a score is stored in association with the user account, and the machine readable instructions, when executed by the processor, further cause the computing device to at least:
scrape a previously identified web page to identify a review associated with an organizational account associated with the user account;
evaluate the review; and
adjust the score based at least in part on an evaluation of the review.

20. The system of non-transitory computer readable medium 15, wherein the machine readable instructions, when executed by the processor, further cause the computing device to at least adjust the incentive award based at least in part on the score.
